(19) United States
(12) Patent Application Publication
(10) Pub. No.: US 2021/0337813 A1
(43) Pub. Date: Nov. 4, 2021

(54) COMPOSITION, DOUGH COMPOSITION, AND METHOD OF PRODUCING DOUGH FOR BREAD OR BAKED GOODS

(71) Applicants: Takai Foods Ltd., Mitsuke-city, Niigata (JP); Sumitomo Corporation, Tokyo (JP)

(72) Inventors: Masazumi KUMAZAWA, Mitsuke-city (JP); Yoichiro TAKAI, Mitsuke-city (JP); Hiroyuki INAGAKI, Tokyo (JP)

(73) Assignees: Takai Foods Ltd., Mitsuke-city, Niigata (JP); Sumitomo Corporation, Tokyo (JP)

(21) Appl. No.: 16/609,093

(22) PCT Filed: Aug. 8, 2018
(86) PCT No.: PCT/JP2018/029831

§ 371 Date: Oct. 28, 2019

(51) Int. Cl. A21D 2/26; A21D 13/047; A21D 2/18; A21D 13/066

(52) U.S. Cl. CPC A21D 2/265; A21D 13/066; A21D 2/181; A21D 13/047

(57) ABSTRACT

An object of the present invention is to provide a composition capable of providing a bread and a sweet stuff having a more delicious and drying-resistant by using a wide various inexpensive coarse cereals or cereal flours and the like, and to provide bread etc., which do not have generation of caving after baking, or have a pot growth. A composition according to the present invention is characterized by comprising rice hydrolyzate, brown rice hydrolyzate, and agar. Furthermore, in a preferred embodiment of a composition according to the present invention, it is characterized in that the dissolution temperature of the agar is 60 to 100° C.

### TECHNICAL FIELD

The present invention relates to a composition, a dough composition, and a method of producing dough for bread or baked goods, especially relates to a composition, a dough composition, and a method of producing dough for bread or baked goods, using a rice flour (powder).

### BACKGROUND ART

In general, a wheat flour or a rye flour is used as a main ingredient of fermented bread, and a wheat bread is preferred to have a puffy texture. It is known that the proteins, gliadin and glutenin contained in these flours are made into gluten having a gum-like visco-elasticity by performing hydrolysis and kneading, this makes it possible to fulfill functions to embed carbon dioxide gas generated by fermentation in the dough to lead to expansion of the volume of a fermented bread.

In the meantime, in Japan, the spread of rice flour bread using rice flour instead of wheat flour is progressing. However, since rice proteins do not contain gliadin and glutenin, they can not form gluten. Therefore, in the past, gluten etc., had to be added separately in order to contain carbon dioxide gas generated during fermentation. For example, in addition to a method of adding glutathione and a method of making bread to which the principle of plastic foam molding is applied, a method of adding gluten and maltose to rice flour (powder) are known (Patent Literature 1).

In addition, in order to impart gluten-like physical properties to rice powder, a method is known in which carboxymethyl cellulose and powdered cellulose are added (Patent Literature 2).

Furthermore, the production of these rice flour breads is required to have a low degree of starch damage and a technique of milling to obtain a fine powder is required.

### PRIOR ART LITERATURE

### Patent Literatures

Patent literature 1: JP-A-2004-222548
Patent literature 2: JP-B-5728402

### DISCLOSURE OF THE INVENTION

### Problems to be Resolved by the Invention

However, rice flour bread products using these methods, including Patent literature 1 described above, there is room for improvement in flavor in all cases. The conventional rice flour bread products are dried rapidly after baking to harden the dough and have a problem that their size shrinks with time, especially the tendency is remarkable after freezing and thawing. In the case of gluten addition, there was a problem of wheat allergy.

Further, apart from rice flour bread by the method according to Patent literature 2, there is a need to be responsive to the wider range of health consciousness of those who prefer rice flour bread.

In addition, rice flour used in Japan at present, for example, including the prior art, is mainly rice flour milled by an air flow grinding method using soaked rice. Here, when this flour milling method is not common in other countries, there is a problem that local procurement is difficult and the local procurement price of exports is high.

On the other hand, for example, in the United States, it is possible to procure a wide variety of coarse cereal or cereal flour easily such as rice flour with large average particle size, amaranth flour, quinua flour, chickpea flour, tef flour, oat barley flour, white sorghum flour, millet flour, etc. Therefore, there is a need for bread and sweet stuff using such coarse cereals or cereal flours.

Moreover, agar is a material that is expected to be applied to a wider range of foods from the viewpoint of various food requirements such as the above-mentioned health intentionality, vegetarian response and halal response.

Therefore, an object of the present invention is to provide a composition capable of providing a bread and a sweet stuff having a more delicious and drying-resistant by using a wide various inexpensive coarse cereals or cereal flours and the like, and to provide bread etc., which do not have generation of caving after baking, or have a pot growth.

### Means of Solving the Problems

In order to attain the above object, the present inventors made strenuous studies regarding various components in addition to coarse cereals or cereal flours.

A composition according to the present invention is characterized by comprising rice hydrolyzate, brown rice hydrolyzate, and agar.

Furthermore, in a preferred embodiment of a composition according to the present invention, it is characterized in that the dissolution temperature of the agar is 60 to 100° C.

Furthermore, in a preferred embodiment of a composition according to the present invention, it is characterized in that the weight average molecular weight of at least one of the rice hydrolyzate and the brown rice hydrolyzate is 200,000 to 5,500,000.

Furthermore, in a preferred embodiment of a composition according to the present invention, it is characterized in that as to a viscosity of the rice hydrolyzate and the brown rice hydrolysate, a final viscosity by viscosity analysis using a rapid visco analyzer at a solid content of 10% is 10 to 200 mPa·s.

Furthermore, in a preferred embodiment of a composition according to the present invention, it is characterized in that the weight ratio of the agar at a dry state to the total amount of the composition is 7 to 10%.

Furthermore, in a preferred embodiment of a composition according to the present invention, it is characterized in that the weight ratio of the brown rice hydrolyzate to the total amount of the composition is 40 to 53%.

Furthermore, in a preferred embodiment of a composition according to the present invention, it is characterized in that the weight ratio of the rice hydrolyzate to the total amount of the composition is 40 to 53%.

Furthermore, a dough composition is characterized by comprising the composition according to the preset invention, a cereal and an expanding agent.

Furthermore, in a preferred embodiment of a dough composition according to the present invention, it is characterized in that the cereal is gluten free.

Furthermore, a dough according to the present invention is characterized by being obtained by adding water to the dough composition according to the present invention and kneading a mixture of the dough composition and water.

Furthermore, a bread according to the present invention is characterized in that the dough according to the present invention is a bread dough, and the bread dough is baked after the bread dough is fermented.

Furthermore, a baked good according to the present invention is characterized in that the dough according to the present invention is a dough for the baked good, and the baked good is produced by heating the dough after the dough for the baked good is fermented.

Furthermore, a method of producing a dough for bread or baked good according to the present invention is characterized by comprising a step of mixing a cereal flour, water, an expanding agent and saccharides, wherein the method comprises a step of blending rice hydrolysate, brown rice hydrolysate and agar in addition to the cereal flour.

Furthermore, in a preferred embodiment of a method of producing a dough for bread or baked good according to the present invention, it is characterized in that the blending amount of a mixture comprising the rice hydrolyzate, the brown rice hydrolyzate and the agar is 5 to 30% by weight based on the total amount of the powder component of the dough.

Furthermore, in a preferred embodiment of a method of producing a dough for bread or baked good according to the present invention, it is characterized in that the cereal flour is gluten free.

### Effect of Invention

According to the composition of the present invention and the dough containing the composition, in various coarse cereal bread and cereal flour bread, by blending brown rice decomposition products, dimensional stability can be obtained and generation of caving can be suppressed. And by blending the agar and the degraded rice decomposition product, carbon dioxide gas can be contained in the bread to expand the volume. In addition, according to the dough composition and dough of the present invention, a bread can be provided by using various coarse cereal etc., without the materials required for conventional method of making a bread, such as gluten, glutathione, food additives etc. In addition, it is possible to provide a bread and a sweet stuff (confection) capable of being compatible with wheat, milk and eggs to consumers if no other materials derived from wheat, milk and eggs are added. Furthermore, it is possible to provide a bread and a sweet stuff consisting only of plant material to consumers who need to avoid animal food.

According to the composition of the present invention, there is an advantageous effect that a bread and a sweet stuff can be manufactured beyond the common knowledge in conventional method of manufacturing the bread. That is, according to the composition of the present invention, there is an advantageous effect that a bread and a sweet stuff can be manufactured without being restricted by conventionally used conditions such as conventional grinding conditions and starch damage degree in bread making using rice flour, and further it is not bound by the conventionally known use of the coarse cereals and the cereals (grains) etc., which is not easy to use. Moreover, according to the dough composition of the present invention, there is an advantageous effect of enabling the production of bread and sweet stuff in accordance with the broad needs of consumers without using gluten and the like.

In addition, the bread and the sweet stuff obtained by the present invention exhibits an advantageous effect that the bread and the sweet stuff have little deterioration in taste due to the passage of time, and are also less susceptible to deterioration in taste due to cold storage and frozen storage.

### BRIEF DESCRIPTION OF THE DRAWINGS

FIG. 1 shows a bread made by using amaranth as cereals according to one embodiment of the present invention.

FIG. 2 shows a bread made by using quinoa as cereals according to one embodiment of the present invention.

FIG. 3 shows a bread made by using galvanso beans as cereals according to one embodiment of the present invention.

FIG. 4 shows a bread made by using tef as cereals, according to one embodiment of the present invention.

FIG. 5 shows a bread made by using oats as cereals according to one embodiment of the present invention.

FIG. 6 shows a bread made by using sweet sorghum as cereals according to one embodiment of the present invention.

FIG. 7 shows a bread made by using rice flour as cereals according to one embodiment of the present invention.

FIG. 8 shows a bread made by using millets as cereals according to one embodiment of the present invention.

FIG. 9 shows a comparison of two results in the case that the agars formulated in white sorghum flour are changed to be baked, according to one embodiment of the present invention.

FIG. 10 shows a comparison of two results in the case that the agars formulated in millet flour are changed to be baked, according to one embodiment of the present invention.

FIG. 11 shows a comparison of two results in the case that the agars formulated in rice flour are changed to be baked, according to one embodiment of the present invention.

### MODE FOR CARRYING OUT THE INVENTION

The composition of the present invention is characterized by comprising rice hydrolyzate, brown rice hydrolyzate and agar. As to rice or brown rice which can be used for rice hydrolyzate or brown rice hydrolyzate, it is as follows. As rice used in a preferred embodiment of the present invention, rice starch or rice grains made from nonglutinous rice, glutinous rice or the like can be used. Examples of rice grains may include those of refined (polished or clean) rice, brown rice, crashed rice and old rice. Moreover, as a rice hydrolyzate, a refined rice hydrolyzate can be preferably mentioned from a viewpoint of improving taste or reducing the oxidation smell or degradation smell (grain smell) of fats and oils. In the present invention, any one kind or a combination of rice and rice grains can be used in place of refined rice. The composition of the present invention can be a composition for food, preferably a composition for dough.

In addition, in the present invention, rice flour (powder) can also be used as rice. In general, a rice flour means those of polishing a raw rice without distinction of a nonglutinous rice and a glutinous rice, and breaking and powderizing the raw rice. Although as a raw rice before breaking, mention may be made of a clean rice, a brown rice, a crushed rice and an old rice etc., it is not particularly limited, it can be used as a rice flour for the composition according to the present invention.

Moreover, the average particle size of rice flour is not particularly limited, and may be, for example, 30 to 80 μm. In the present invention, as rice flour, the amount of damaged starch is as small as 5% or less, and from the viewpoint of baking properties of the bread, the average particle size is as small as 30 to 80 μm, and further, the amount of damaged starch is 4% or less, the average particle size is 30˜50 μm can be used, and such rice flour can be used. The method of measuring the average particle size of rice flour can be performed by a method of measuring an approximate particle size by “mesh pass” which is commonly performed in the rice flour industry. Specifically, it is possible to use a sieve type of mesh and to rub with a brush to decide how many macro meter depending on the size of mesh which the particle passes. Therefore, more properly, an average particle size can be 30 to 80 μm if the minimum mesh pass is 150 and maximum mesh pass is 330.

Further, the moisture percentage of the above-mentioned rice-derived flour may be, for example, 10 to 15%.

As the above-mentioned rice flour milling method, any method of barrel milling, roll milling, stone mill milling, air flow milling, wet air milling, and pin milling may be used.

In the present invention, it is possible to obtain rice hydrolyzate or brown rice hydrolyzate using the above-mentioned rice or rice flour or the like.

The above-mentioned rice hydrolyzate or brown rice hydrolyzate can be obtained from the following production method. That is, in a general wet decomposition method regarding decomposition using a starch and/or a starch-containing substance as a raw material, 100% or more of water is added to the raw material to form a suspended state, and heating is performed. After that, the starch in the raw material can be gelatinized to obtain a rice hydrolyzate or a brown rice hydrolysate by means of a method in which decomposition is performed by adding an enzyme or acid.

In addition, the above-mentioned rice hydrolyzate or brown rice hydrolyzate can be obtained from the following production method. That is, a rice hydrolyzate or brown rice hydrolyzate can be obtained by a method comprising the following steps that a starch and/or a starch-containing substance and water are added into the cylinder of the extruder, and the starch and/or the starch-containing substance is compressed, mixed, kneaded, heated and sheared in the cylinder. In addition, in a preferred embodiment, from the viewpoint of an appropriate viscosity at the time of decomposition, the water content of the raw material when adjusted by adding water to the raw material is characterized by being 15 to 50%. If it is less than 15%, there is a possibility that the viscosity may be high in the extruder and an excessive load may be applied to the machine. If it exceeds 50%, the viscosity may be too low to be easily decomposed in the extruder.

In the present invention, the extruder can be a single-screw extruder, a twin-screw extruder, or a tandem type of extruder. As a tandem type of multiple extruder, a cylinder constitution comprising from two stages to five stages is preferable, from a viewpoint of a uniformity of kneading and a degree of freedom, the number of screw existing in each stages is preferably 1 to 8. Although a tandem type of extruder having two stages or more of cylinder constitution is preferable, from a viewpoint of mass productivity, a simpleness of maintenance, two stages to three stages of cylinder constitution is particularly preferable. The extruder is a tandem type of extruder, wherein the extruder may be a three-stage type comprising an upper stage cylinder, a middle stage cylinder and a lower stage cylinder, or a two-stage type comprising an upper stage cylinder and a lower stage cylinder, and the temperature of the upper stage cylinder may be 100 to 150° C., and the temperature of the middle stage cylinder may be 100 to 200° C., and the temperature of the lower stage cylinder may be 100 to 200° C. The temperature of an input port cylinder of the raw material can be set to 100° C. or less in the above-mentioned extruder treatment.

In a preferred embodiment of a composition according to the present invention, it is characterized in that the weight average molecular weight of at least one of the rice hydrolyzate and the brown rice hydrolyzate is 200,000 to 5,500,000, from the viewpoint of baking properties of the bread. This is because that if it is less than 200,000, there is a possibility that the bread may not expand, and if it exceeds 5,500,000, there is a possibility that the molecule may be too large and, conversely, it may aggregate and the bread may be crushed at the time of baking (there is a risk of being cracked).

Moreover, in the present invention, the weight average molecular weight can be measured according to the following method. That is, after preparing an aqueous solution with a solid concentration of 1% and filtering it with a 0.45 μm filter, using a gel filtration type of column such as columns manufactured by Showa Denko KK or Tosoh Corporation, a sample of various molecular weights can be used as a standard. And the weight average molecular weight can be measured by conventional gel filtration chromatography.

In a preferred embodiment of a composition according to the present invention, it is characterized in that as to a viscosity of the rice hydrolyzate and the brown rice hydrolysate, from the viewpoint of baking properties of the bread and holding the shape of the bread, a final viscosity by viscosity analysis using a rapid visco analyzer at a solid content of 10% is 10 to 200 mPa·s. This is because that if the viscosity is less than 10 mPa·s, there is a possibility that the bread may not expand because the viscosity is too low, if the viscosity exceeds 200 mPa·s, there is a possibility that the bread may be crushed during the baking because the viscosity is too high.

In the present invention, the above-mentioned final viscosity is as follows. That is, in the case that an aqueous solution with a solid concentration of 10% is prepared and stirred at 35° C. for 21 minutes at RVA-4500 (manufactured by Fos Japan Co., Ltd.) to be heated at 5° C./minute over 21-33 minutes, and heated at 95° C. for 10 minutes, after that, the solution is cooled at 5° C./minute and further cooled up to 50° C., the final viscosity indicates the viscosity when the temperature is raised to 95° C. and then cooled to 50° C.

In addition, in a preferred embodiment of the composition according to the present invention, the weight ratio of the brown rice hydrolyzate to the total amount of the composition is 40 to 53%, from the viewpoint of baking properties of the bread.

In a preferred embodiment of the composition of the present invention, the weight ratio of the rice hydrolyzate to the total amount of the composition is 40 to 53%, from the viewpoint of baking properties of the bread. In addition, the combination ratio of rice, for example, refined rice hydrolyzate and brown rice hydrolyzate can be determined in consideration of the texture balance (functionality). In order to finish texture lightly and softly, for example, the ratio of refined rice decomposed material may be increased, the ratio of brown rice decomposed material may be decreased, or the above-mentioned composition ratio may be reversed when hard texture is to be finished. However, while brown rice hydrolyzate has an important function and the cellulose (insoluble dietary fiber) contained in the brown rice hydrolyzate can be a structural material, an easily soluble agar can encompass carbon dioxide produced by fermentation in bread dough like a rubber balloon, cellulose in brown rice decomposition product can contribute to the “retention (stick) of the balloon”. To produce this effect, the brown rice hydrolyzate can preferably be at least 40%, and the value of the compatible rice hydrolyzate will also be set.

Further, in the present invention, although not only refined rice hydrolyzate but also brown rice hydrolyzate and agar, preferably easily soluble agar, can be contained, for example, this is because of aiming at the following synergistic effects of the two components. That is, it is possible to impart dimensional stability by the insoluble dietary fiber contained in the brown rice hydrolyzate and to suppress the occurrence of caving. And, by blending the refined rice hydrolyzate and agar, carbon dioxide gas can be contained in bread and sweet stuff using various miscellaneous cereals and cereals (grains), and volume expansion can be performed.

Next, the agar usable in the present invention is, for example, as follows. In a preferred embodiment of the present invention, the agar can be produced, for example, from that which has been subjected to bleaching treatment from Tengusa or Ogonori.

In the present invention, as agar, an easily soluble agar can be used which has a dissolution temperature in a solvent (eg, hot water) of 60 to 100° C. Thus, the agar in which the dissolution temperature in the solvent is specified may be referred to as “easily soluble agar”.

The dissolution temperature of the above-mentioned easily soluble agar is, for example, preferably 70 to 80° C. in view of the rise in internal temperature at the time of baking, and particularly preferably about 80° C., when emphasis is placed on texture. Specifically, the trade name Speed Agar 80 manufactured by Thai Show Technos Co., Ltd. and INA AGAR UP-175 manufactured by Ina Food Industry Co., Ltd. can be suitably used.

The above-mentioned easily soluble agar, for example, can be produced by comprising a step of adding water in an amount of 100 to 300 parts by weight of water to 100 parts by weight of agar, and heat-treating the watered agar so that the water does not foam in the extruder, and a step of dissolving and solidifying the agar, and a step of grinding and drying the solidified agar with a grinder/dryer, but the agar thus obtained can also be used in the present invention.

The above-mentioned easily soluble agar can be easily dunk in water and easily dissolved in hot water (around 73° C.) in a pot, and can be a dried agar in which an object containing agar gelates well. This easily soluble agar may be, by way of example, hydrolyzing dry powder agar, followed by a step of heat treatment so as not to foam it with an extruder and a step of pulverizing with a pulverizing drier continuously. Hereinafter, the easily soluble agar may be manufactured by controlling the particle size of the pulverized product to 100 μm or less and controlling the bulk specific gravity to 0.5 g/cm 3 or more.

General agar, even when the agar is granulated or not granulated, forms a very strong cross-linked structure by hydrogen bonding with water molecules coexisting in the dissolved agar at the stage of forming a higher-order structure, it is converted into an unusual stable molecular form (association helix) to construct a very specific gel structure. Therefore, even if the particle size is adjusted using the same mesh path, it has the characteristic that the variation in size is small. Moreover, general agar may take time during operation when it is dissolved in a pot of hot water, or the temperature of the hot water may vary and remain undissolved due to the difference in the heating of the pot and the heat retaining function,

The above-mentioned easily soluble agar has larger size variations than the above-mentioned general agar, and a large number of finer particles are present in the easily soluble agar, and the total surface area of the agar surface of the easily soluble agar is large compared to agar extracted from red algae before treatment. The easily soluble agar used in the present invention may have its particle size defined as follows so as not to be rough.

The particle size of the powder in the dry substance of the above-mentioned easily soluble agar may be between 38 μm pass and 670 μm pass or less than or equal to 200 μm pass. With such a particle size range, the agar can be adjusted to sink in a fixed time, and the agar can be dissolved before it burns even if it settles out during heating.

Further, in a preferred embodiment, the particle size of the dry powder of agar may be 100 μm or less, from the viewpoint of making it difficult to feel roughness more reliably even if it remains undissolved due to the temperature of the hot water of the pot.

For example, the following method is available as a method for producing an easily soluble agar applicable to the present invention, and the agar obtained thereby can also be used in the present invention.

(1) A predetermined amount of water is added to the agar powder (for example, TS agar ISP-9 manufactured by Taisho Technos) and mixed by wet mixing, then it is supplied to a twin screw corotating extruder and heat treated so as not to cause foaming the mixture. The heat treatment conditions are 170° C., and the screw rotation speed is 200 rpm.
(2) The heat-treated agar can be obtained as a spherical agar which has elasticity and is free of voids without being cut by a cutter or the like.
(3) The finished spherical agar is discharged from the extruder and immediately dried and crushed by a dry crusher. The drying and grinding conditions are a drying temperature of 80° C. The dried and crushed agar is sieved by a vibrating sieve and prepared to have a size of 180 μm or less.

In a preferred embodiment of the composition according to the present invention, it is characterized in that the weight ratio of the agar at a dry state to the total amount of the composition (composition containing rice hydrolyzate, brown rice hydrolyzate and agar) is 7 to 10%, from the viewpoint of baking property. As described above, while cellulose (insoluble dietary fiber) contained in brown rice hydrolyzate can become a structural material, an agar, preferably an easily soluble agar can encompass carbon dioxide produced by fermentation in bread dough like a rubber balloon, cellulose in brown rice decomposition product can contribute to the “retention (stick) of the balloon”.

Next, one example of the dough composition of the present invention will be described as follows. The dough composition of the present invention is characterized by comprising the composition of the present invention described above, cereals and the expanding agent. For the composition of the present invention, reference can be made to the above description.

In the present invention, the cereal is also not particularly limited. For example, the cereal capable of using for the dough composition and the dough according to a preferred embodiment of the present invention is not limited to a particular coarse cereal or cereal. Moreover, as said cereal (grain), one type may be used out of various miscellaneous coarse cereals and cereal, and a combination of multiple types may be used.

In addition, as cereal, cereal flour can also be used, and the said cereal flour can be manufactured by any method of barrel milling, roll milling, stone mill milling, airflow milling, wet airflow milling, and pin milling. For example, as a cereal flour, amaranth flour, quinoa flour, galvanzo bean flour, tef flour, oat flour, sweet sorghum flour, roll milled rice flour, millet flour and the like can be mentioned. Moreover, the average particle size of the cereal flour is not particularly limited, and for example, the average particle size may be 30 to 200 μm, preferably 30 to 180 μm, from the viewpoint of bread making properties. The measurement of the average particle size is the same as in the case of the above-mentioned rice flour.

In addition, in the present invention, as the expanding agent, commercially available products such as baking powder, yeast, dry yeast and the like can be included, and these can be used. Furthermore, from the viewpoint of wheat allergy, a binder and live yeast which does not use wheat as a raw material at the time of culture.

The bread dough or the sweet stuff base dough composition according to a preferred embodiment of the present invention may contain saccharides in addition to the composition described above, coarse cereals, cereal flour and an expanding agent (and/or yeast). Moreover, the said dough composition may contain salt, sugar, skimmed milk powder, fats and oils, an egg, a soy lecithin etc., similarly to normal wheat flour bread. These are not particularly limited, and can be appropriately set in accordance with the consumer's desire for bread and sweet stuff, and commercially available products may be arbitrarily applied. For example, skimmed milk powder, a specific expanding agent, or an egg may not be used as needed from the viewpoint of allergy response, vegetarian response and the like.

In a preferred embodiment of the dough composition according to the invention, the cereal is characterized in that it is free of gluten. This is because, as described above, in the present invention, by mixing refined rice hydrolyzate and agar, carbon dioxide gas can be contained in the bread and the sweet stuff using various miscellaneous coarse cereals and cereals, and volume expansion of the bread etc., can be performed, and, in particular in rice flour-based compositions, as it is not necessary to add gluten separately.

In the dough composition of the present invention, the addition amounts of the above-mentioned rice hydrolyzate, brown rice hydrolyzate and agar are preferably 9 to 20 parts by weight, and are in particular, preferably 9 to 15 parts by weight with respect to 150 parts by weight of cereals, from the viewpoint of “sudachi” formation (Traces of air bubbles that appear in the cross section of sliced bread) and texture maintenance in bread. In addition, a word “sudachi” means a term which shows bubble dispersion in bread.

In addition, the dough of the present invention is characterized by being obtained by adding water to the dough composition of the present invention and kneading it. The above description can be referred to for the dough composition of the present invention. A bread dough as an example of a dough according to a preferred embodiment of the present invention can be obtained by adding water to the above-mentioned dough composition and kneading it. By using commercially available carbonated water instead of water at the time of water addition, it is also possible to make rice flour bread which is more bloated.

In the case of using coarse cereals, cereal flour, etc. having a moisture content of 11 to 12%, the amount of water addition (the amount of water etc.) when adding water is, for example, 110 to 300 parts by weight, more preferably 150 to 275 parts by weight, and still more preferably 250 to 275 parts by weight relative to 100 parts by weight of rice flour. from the viewpoint of bread making properties. In addition, when mixing liquid components, such as milk and an egg, with dough, the water in these liquid components can also be added to the said water content. The mixing can be performed using a mixer, a hand mixer or any other device. The mixing may be performed at high speed for about 2 minutes from the viewpoint of bread making properties, until the dough becomes smooth.

In addition, the bread of the present invention is characterized in that the dough of the present invention is bread dough, and the bread dough is baked after being fermented. There is no particular limitation on fermentation and baking. For example, after fermenting the mixed dough in hot water at 50° C. for 10 to 20 minutes and molding it into a predetermined shape, using any device such as a bakery oven or a microwave oven with an oven function, the baking can be performed for about 30 to 50 minutes under a temperature condition of 230 to 250° C. to form a bread. Breads obtained in this manner include a wide variety of breads obtained by fermentation such as a plain bread (sandwich bread), coppe bread (similar to a hot dog bun), French bread and the like, but are not limited as long as they are obtained by the composition of the present invention.

Further, the baked good (such as sweet stuff or confectionery etc.) of the present invention is characterized in that the dough of the present invention is a baked good dough, and the baked good is produced by heating after fermenting the baked good dough. The kneaded dough can be fermented in the same manner as bread and then steamed or baked to make a sweet stuff or a confectionery. The sweet stuff thus obtained is not particularly limited as long as it is obtained by the composition of the present invention.

Moreover, the method for producing the bread or the baked good dough according to the present invention is characterized in that a method for producing the bread or the baked good dough comprises the step of mixing cereal flour, water, an expanding agent, and a saccharide, the method is characterized by including a step of blending rice hydrolyzate, brown rice hydrolyzate, and agar in addition to the cereal flour. In the present invention, as cereals (powder) and expanding agents, the description of the above-mentioned dough composition of the present invention can be applied as it is to cereals and expanding agents. In the present invention, the step of mixing the cereal flour, water, the expanding agent, and the saccharide is not particularly limited by a conventional method. In addition, the description of the composition and the like of the present invention described above can be applied as it is to rice hydrolyzate, brown rice hydrolyzate and agar.

In a preferred embodiment of the method for producing the bread or baked good dough according to the present invention, it is characterized in that the blending amount of the blend comprising the rice hydrolyzate, the brown rice hydrolyzate, and the agar is 5 to 30% by weight with respect to the total amount of a powder component of the dough (Specifically, cereal flour, expanding agent (and/or yeast), and saccharides), from the viewpoint of bread making property. In a preferred embodiment of the production method of the present invention, the cereal flour is characterized by being free of gluten. This is because, as described above, in the present invention, by mixing refined rice hydrolyzate and agar, carbon dioxide gas can be contained in the bread and the sweet stuff using various miscellaneous coarse cereals and cereals, and volume expansion of the bread etc., can be performed, and, in particular in rice flour-based compositions, as it is not necessary to add gluten separately.

In addition, the combination ratio of the above-mentioned refined rice hydrolyzate and brown rice hydrolyzate can be changed according to the texture balance (functionality). In order to finish the texture softer, the ratio of the refined rice hydrolyzate may be increased and the ratio of the brown rice hydrolyzate may be decreased. If you want to make the texture more hard, it is possible to lower the ratio of the refined rice hydrolyzate and increase the ratio of the brown rice hydrolyzate.

On the other hand, cellulose (insoluble dietary fiber) contained in the brown rice hydrolyzate becomes a structural material, easily soluble agar contains carbon dioxide generated by fermentation of dough like a balloon, and cellulose is used for retention of balloons. As the effect of this structural material, there may be some condition that the brown rice hydrolyzate has a minimum required proportion in the total amount of hydrolyzate. In one example, this percentage of the brown rice hydrolyzate can be about 40%.

### EXAMPLE

At this moment, the present invention will be concretely explained in more detail with reference to Examples below, but the invention is not intended to be interpreted as being limited to Examples. Moreover, it is possible to change appropriately without departing from the scope of the invention.

### Example 1

At first, as a composition of the present invention, a composition containing rice hydrolyzate, brown rice hydrolyzate, and agar was prepared. As rice, refined rice was used. Specifically, 7.3% by weight of rice hydrolyzate (JU-800A, manufactured by Takai Foods Co., Ltd.), 43.6% by weight of brown rice hydrolyzate (GU-800A, manufactured by Takano Foods Co., Ltd.), 48.8% by weight of agar (TS agar ISP-9, manufactured by Thailand Show Technos Co., Ltd., Speed Agar 80, manufactured by Thailand Show Technos Co., Ltd. or INA AGAR UP-175, manufactured by Ina Food Industry Co., Ltd.) were used. In addition, KGS-541 manufactured by Tada Foods Co., Ltd., can be used as a composition.

### Example 2

The composition of the present invention thus obtained was attempted to be used as a food in the following examples. First, in fact, the composition of the present invention was used to make the dough composition of the present invention. As the dough composition, in addition to the composition of the present invention, white superior soft sugar, trehalose, salt, yeast, shortening, warm water (50° C.) were used. The composition and mixing ratio of the dough composition are as follows.

Total of the composition of the present invention (KGS-541) and coarse

cereals/cereals: 150 g
White superior soft sugar: 15 g

### Trehalose: 15 g

### Salt: 1.2 g

### Yeast: 2.4 g

### Shortening: 12 g

Hot water (50° C.): 130.5 g

First, a dough was prepared using the above dough composition. That is, using a trade name K5SS (manufactured by Kanto Mixed Industry Co., Ltd.) for mixing, the mixture was stirred at high speed for 2 minutes and then fermented at 50° C. for 20 minutes to produce a dough. Thereafter, the dough was poured into a mold and baked at 230° C. for 40 minutes using an oven function of a trade name MRO-JV300 (manufactured by Hitachi Home Appliances Co., Ltd.) to produce a bread.

As the coarse cereals and cereals to be tested, in the case that cereal flours such as amaranth, quinoa, galvanzo beans (chickpeas), tef, oats, sorghum, rolled flour, rice flour, millet, etc., are used, the results of Examples (Examples 1 to 8) will be described, in which the weight proportions of both the coarse cereals and cereals flours to be tested and the composition are changed when the mixture of the coarse cereals and cereals flours to be tested and the composition is 100%.

### Example 3

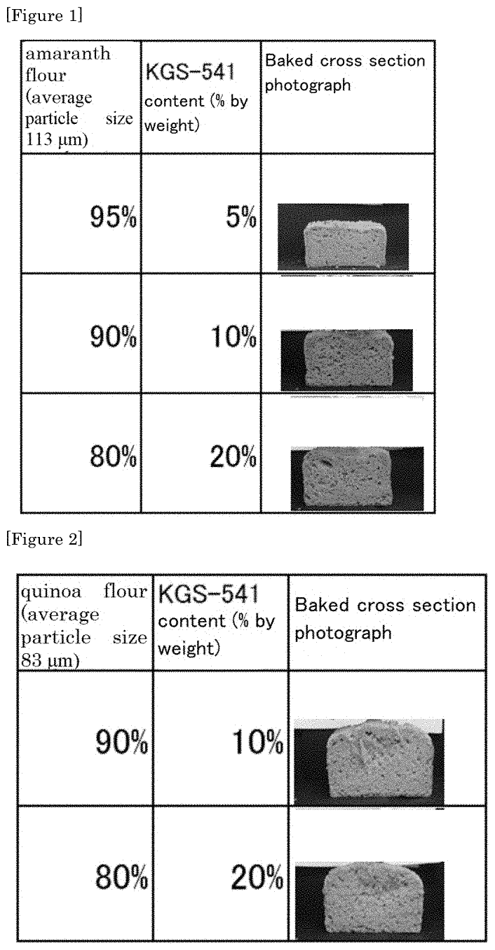

Evaluation of the dough composition and the bread using the dough composition of the present invention when using amaranth flour as cereal flour, was performed. From the results shown in FIG. 1, with regard to amaranth flour (average particle size 113 μm), 10% bread is more swollen than bread 5% by weight of the composition, but in the case of 20% bread, it was revealed that the sparseness or rough “sudachi” of the bubble mark was noticeable while the bulging.

### Example 4

Next, evaluation of the dough composition and the bread using the dough composition of the present invention when using quinoa flour as cereal flour, was performed. With regard to the quinoa powder (average particle diameter 83 μm) shown in FIG. 2, the swelling was good when the composition was introduced. And it was revealed that “sudachi” which is 20% of the weight ratio of the composition, was more uniform than that of 10%.

### Example 4

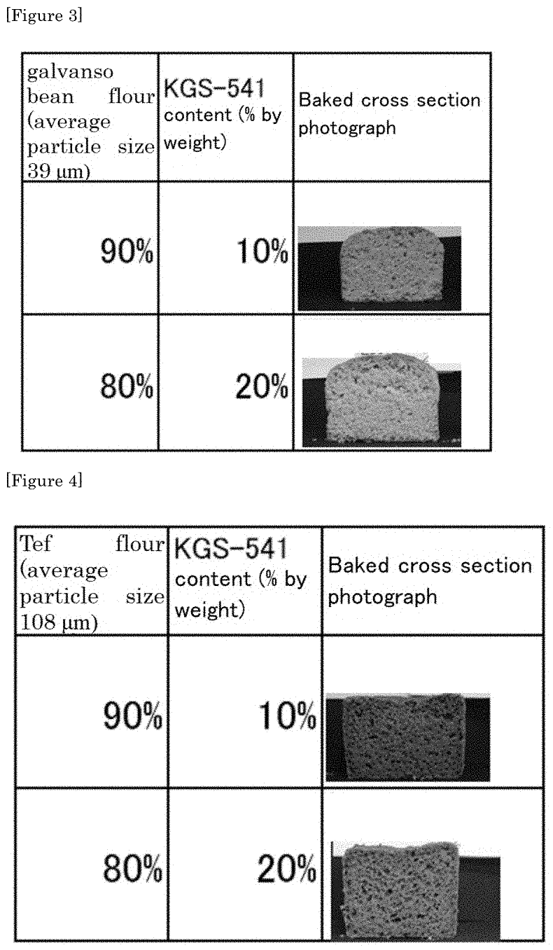

Next, evaluation of the dough composition and the bread using the dough composition of the present invention when using galvanso bean flour as cereal flour, was performed. In the case of galvanso bean flour (average particle size 30 μm) shown in FIG. 3, it was revealed that a 20% bread had a better swelling and “sudachi” thereof was better than a bread having 10% of the weight ratio of the composition.

### Example 5

Next, evaluation of the dough composition and the bread using the dough composition of the present invention when using Tef flour as cereal flour, was performed. In the case of Tef flour (average particle size 108 μm) shown in FIG. 4, in both a bread with 10% of the weight ratio of the composition and a bread with 20% of the weight ratio of the composition, the “sudachi” were sufficiently uniform, but it was revealed that the bread with 20% bread had a better swelling.

### Example 6

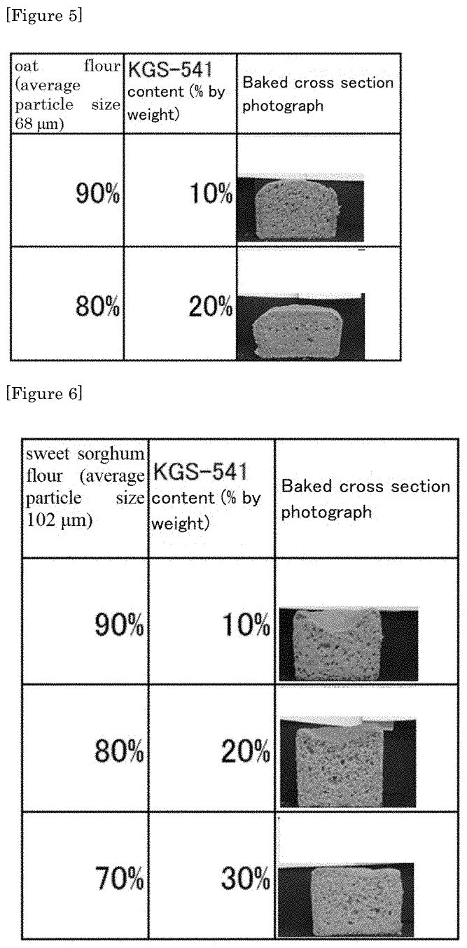

Next, evaluation of the dough composition and the bread using the dough composition of the present invention when using oat flour as cereal flour, was performed. With respect to the oats flour (average particle diameter of 68 μm) shown in FIG. 5, it was revealed that the bread having 10% of the weight ratio of the composition had a better swelling than the bread having 20% of the weight ratio of the composition.

### Example 7

Next, evaluation of the dough composition and the bread using the dough composition of the present invention when using sweet sorghum flour as cereal flour, was performed. In the sweet sorghum flour (average particle size 102 μm) shown in FIG. 6, the bread having 30% of the weight ratio of the composition had a better swelling than both the bread having 10% of the weight ratio of the composition and the bread having 20% of the weight ratio of the composition, an almost uniform swelling was achieved.

### Example 8

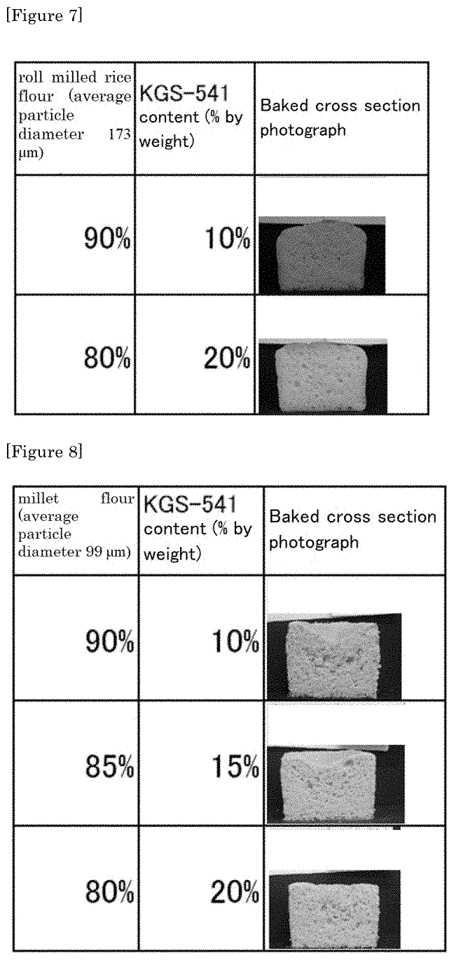

Next, evaluation of the dough composition and the bread using the dough composition of the present invention when using roll milled rice flour as cereal flour, was performed. With respect to the roll milled rice flour (average particle diameter: 173 μm) shown in FIG. 7, the bread having 10% of the weight ratio of the composition and the bread having 20% of the weight ratio of the composition achieved both good swelling and “sudachi”.

### Example 9

Next, evaluation of the dough composition and the bread using the dough composition of the present invention when using millet flour as cereal flour, was performed. For the millet flour shown in FIG. 8 (average particle size 99 μm), the bread having 20% of the weight ratio of the composition had a better swelling than both the bread having 10% of the weight ratio of the composition and the bread having 15% of the weight ratio of the composition, an almost uniform swelling was achieved.

From these results, it was found that the rice flour bread obtained by the present invention was all less deteriorated such as a decrease in water content, and was easy to store under refrigeration or freezing.

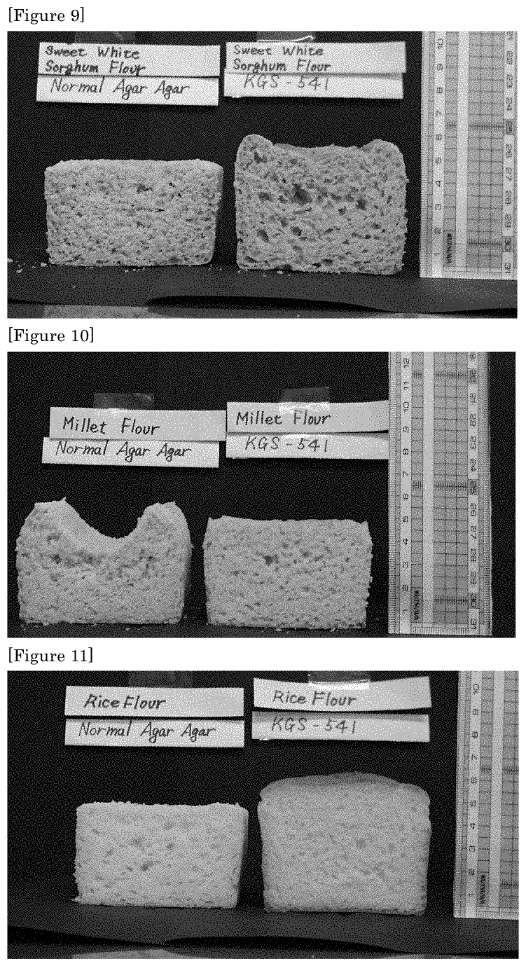

FIG. 9 shows a comparison of two results in the case that a composition containing common agar (which is represented as “Normal Agar Agar” in the figure) in addition to the white sorghum flour is baked, and a composition containing an easily soluble agar, for example, KGS-541 in addition to the white sorghum flour is baked. It is recognized that bread obtained by using a general agar have less swelling than that of using an easily soluble agar and therefore exhibit a harder texture.

FIG. 10 shows a comparison of two results in the case of both a bread obtained by using a composition containing a common agar in addition to millet flour and a bread obtained by using a composition containing an easily soluble agar in addition to millet flour. Those using a common agar have less uniformity “sudachi” than those using an easily soluble agar, so it can be recognized that this uneven distribution leads to variations in texture.

FIG. 11 shows a comparison of two results in the case of those using a common agar and those using an easily soluble agar. The status of “sudachi” of the bread using the common agar appears to be comparable to bread using the easily soluble agar. However, the overall swelling of the bread using the common agar is poorer than that of using the easily soluble agar, and therefore it can be recognized that the bread using the common agar exhibits a harder texture.

As described above, it was revealed that by using the composition of the present invention containing the rice hydrolyzate, brown rice hydrolyzate and agar, the conventional common sense of a manufacture of a rice flour bread is reversed, and a bread and a confectionery having a good puffiness (swelling) and “sudachi” can be manufactured. That is, it has been revealed that the present invention is not restricted to conventional manufacturing conditions such as coarse cereals and cereals (grains), and it is possible to manufacture breads and confections meeting the broad needs of consumers without using gluten etc.

### INDUSTRIAL APPLICABILITY

In recent years, since effective utilization of rice such as rice powder become serious problems and in particular, the rice powder can be substituted for a principal food component such as rice or bread etc., the present technics can be applied for a wide variety of fields.

1. A composition comprising rice hydrolyzate, brown rice hydrolyzate, and agar.

2. A composition according to claim 1, wherein the dissolution temperature of the agar is 60 to 100° C.

3. A composition according to claim 1, wherein the weight average molecular weight of at least one of the rice hydrolyzate and the brown rice hydrolyzate is 200,000 to 5,500,000.

4. A composition according to claim 1, wherein as to a viscosity of the rice hydrolyzate and the brown rice hydrolysate, a final viscosity by viscosity analysis using a rapid visco analyzer at a solid content of 10% is 10 to 200 mPa·s.

5. A composition according to claim 1, wherein the weight ratio of the agar at a dry state to the total amount of the composition is 7 to 10%.

6. A composition according to claim 1, wherein the weight ratio of the brown rice hydrolyzate to the total amount of the composition is 40 to 53%.

7. A composition according to claim 1, wherein the weight ratio of the rice hydrolyzate to the total amount of the composition is 40 to 53%.

8. A dough composition comprising the composition according to claim 1, a cereal and an expanding agent.

9. A dough composition according to claim 8, wherein the cereal is gluten free.

10. A dough obtained by adding water to the dough composition according to claim 8 and kneading a mixture of the dough composition and water.

11. A bread wherein the dough according to claim 10 is a bread dough, and the bread dough is baked after the bread dough is fermented.

12. A baked good wherein the dough according to claim 10 is a dough for the baked good, and the baked good is produced by heating the dough after the dough for the baked good is fermented.

13. A method of producing a dough for bread or baked good comprising a step of mixing a cereal flour, water, an expanding agent and saccharides, and the method comprising a step of blending rice hydrolysate, brown rice hydrolysate and agar in addition to the cereal flour.

14. A method according to claim 13, wherein the blending amount of a mixture comprising the rice hydrolyzate, the brown rice hydrolyzate and the agar is 5 to 30% by weight based on the total amount of the powder component of the dough.

15. A method according to claim 13, wherein the cereal flour is gluten free.
